(19) United States
(12) Patent Application Publication
(10) Pub. No.: US 2025/0391217 A1
(43) Pub. Date: Dec. 25, 2025

(54) VOTE TABULATING MACHINE

(71) Applicant: Daniel Robert Shepard, Stratham, NH (US)

(72) Inventor: Daniel Robert Shepard, Stratham, NH (US)

(21) Appl. No.: 19/244,111

(22) Filed: Jun. 20, 2025

Related U.S. Application Data
(60) Provisional application No. 63/662,448, filed on Jun. 21, 2024.
(60) Provisional application No. 63/711,040, filed on Oct. 23, 2024.

(51) Int. Cl. G07C 13/00

(52) U.S. Cl. CPC G07C 13/00

(57) ABSTRACT

Voting machines must be highly trusted by the public in order for results to be accepted. But a voting machine that takes the form of a black box is suspect because it cannot be examined or easily understood by the voting population. The present invention is an electronic voting machine that is reliable, easy to configure for any election, transparent, and unhackable. The present electronic voting machine is manufactured using readily available digital component parts and basic analog circuitry without using any software.

### CROSS-REFERENCE TO RELATED APPLICATION

This Patent Application makes reference to U.S. Provisional Patent Application 63/662,448 by Shepard titled “VOTE TABULATING MACHINE” that was filed on Jun. 21, 2024 and U.S. Provisional Patent Application 63/711,040 by Shepard titled “VOTE TABULATING MACHINE” that was filed on Oct. 23, 2024, and those applications are incorporated herein in their entireties by reference.

A system and method for tabulating votes marked on a ballot.

### TECHNICAL FIELD

In various embodiments, the present invention relates to voting machines and in particular to voting machines that are fast, transparent, accurate, and unhackable.

### BACKGROUND

Voting machines have evolved from their modest beginnings as a box with a slot for inserting a ballot. From early mechanical machines wherein votes were cast by flipping down a lever, to the IBM Votomatic hole punch machine, to modern computerized machines that can scan ballots and count votes, to machines that present an electronic touch screen ballot and tabulation, voting machines are desired for their speed and accuracy.

U.S. Patent 7,521 by Albert Henderson issued in 1850 taught an electrochemical vote recorder for legislative roll-call votes. U.S. Patent 90,646 by Thomas Edison issued in 1869 added electromechanical counters to Henderson to count the votes. U.S. Pat. No. 616,174 by Wood issued in 1898 taught a push-button paperless electrical voting machine. U.S. Pat. No. 3,793,505 by Mckay et al. issued on Feb. 19, 1974, known as the Video Voter, used discreet digital logic but did not use paper ballots and they suffered from such complexity that transparency suffered. U.S. Pat. No. 4,025,757 by Mckay et al. which issued on May 24, 1977 expanded on the concept and added additional complexity (in 56 pages of figures) as well as software programming resulting in further loss of transparency and stating: “Similarly the data center, when re-energized, will return the accumulated totals and other information then on the tape in cartridge 105 over the tape recorder 134 into the memories 135, 136 and 137. This is done automatically under the direction of the steps or “program” stored by reason of the interconnection of the components in the logic circuit 131. The logic circuit, together with the information initially passed from the tape over the recorder 134 into the election configuration memory 137, govern the operation of the complete system.” U.S. Pat. No. 4,021,780 by Narey et al. issued May 3, 1977 taught an optical scanning machine with paper ballots having marking areas in which to cast a vote and edge marks to synchronize the machine with the ballot, but it too suffered from significant complexity (in 46 pages of figures) as well as software programming resulting in loss of transparency. Both machines are among the first potentially hackable voting systems, however even fully mechanical systems could be manipulated by, for example, placing debris in the gears of counters corresponding to candidates whom one desired to have lose the election to prevent accurate counting.

In recent elections, voting machines have been targeted as an opportunity to defraud election counts. Voting machines have recently been suspected of flipping votes or, more simply, of counting votes while ballots are still being cast with those counts being accessed by nefarious actors for the purpose of knowing how many additional votes might be needed for victory such that fraudulent ballots could be inserted into the legitimately cast ballots. Regardless, even the appearance of impropriety is a concern as it leads to distrust of election outcomes. Presently around the country, there is a push for hand counted paper ballots. Opponents of voting machines argue that electronic voting machines are hackable and lack transparency due to the black box nature of computerized systems. Advocates argue that hand counting is too slow and will cause delays in determining election outcomes as well as that hand counting is subject to errors.

What is needed is a way and a device to process hand counted paper ballots that is easy to configure for any election, is fast, transparent, accurate, and unhackable that is sufficiently uncomplicated that a novice engineer and the public can quickly grasp and validate its operation.

### SUMMARY

Voting machines must be highly trusted by the public in order for results to be accepted. But a voting machine that takes the form of a black box is suspect because it cannot be examined or easily understood by the voting population. The present invention is an electronic voting machine that is reliable, easy to configure for any election, transparent, and unhackable. The present electronic tabulating device is manufactured using simple, common digital component parts, basic analog circuitry, and utilizes no software.

By utilizing no software or incoming communication circuits, the present invention is made unhackable. It is constructed entirely with simple circuits and commonly available components such that its design can be published and easily understood. The machine can be put on display for examination or to be photographed before, during and after an election making it transparent. The present invention is a counting device that incorporates safeguards to handle attempts to manipulate the vote by tampering with the scanning of the ballots making it both fast and accurate. Ideally, even the printed circuit boards (PCBs) could be constructed such that all wire traces are visible and traceable (e.g., not covered by the components).

### BRIEF DESCRIPTION OF THE DRAWINGS

In the drawings, like reference characters generally refer to the same parts throughout the different views. Also, the drawings are not necessarily to scale nor do they necessarily include support circuitry that is well understood by those skilled in the art and that, if included, could serve to complicate the drawings and obscure the inventive concepts, emphasis instead generally being placed upon illustrating the principles of the invention. In the following description, various embodiments of the present invention are described with reference to the following drawing, in which:

FIG. 1 depicts a sample ballot.

FIG. 2 depicts a ballot being scanned.

FIG. 3 depicts a schematic of an optical scanner element.

FIG. 4 depicts a schematic of an optical scanner element with a plurality of sensors.

FIG. 5 depicts a schematic of an alternate optical scanner element.

FIG. 6 depicts a side view of row marks on a ballot and positioning of apertures for scanning row marks along with a waveform resulting from an edge mark passing by the apertures.

FIG. 7 depicts a schematic of logic to determine the direction of the ballot scan and conversion of ballot markings into pulses for a ballot row counter.

FIG. 8 depicts a schematic of a row selector circuit.

FIG. 9 depicts a schematic of a clip lead latch circuit.

FIG. 10 depicts a block diagram of the machine Front End comprising a setup grid.

FIG. 11 depicts one of a plurality of ballot marking ovals to which an L-shaped hole is aligned and which is formed through layers of plastic sheets through which a row wire and a column wire passes.

FIG. 12 depicts a clip lead for making a connection to the row and column wires in an L-shaped hole in the closed position.

FIG. 13 depicts a clip lead for making a connection to the row and column wires in an L-shaped hole in the opened position.

FIG. 14 depicts a close-up of the tip of a clip lead in the closed position.

FIG. 15 depicts a close-up of the tip of a clip lead in the opened position.

FIG. 16 depicts a schematic of a vote counting and display circuit.

FIG. 17 depicts a schematic of an over-under-vote indicator circuit.

FIG. 18 depicts a generalized schematic of an over-under-vote circuit.

FIG. 19 depicts a schematic of a current based over-under-vote circuit.

FIG. 20 depicts a schematic of a ballot orientation and validation schematic.

FIG. 21 depicts a generalized serial output circuit for off loading election results.

FIG. 22 depicts a four by four array of keyed holes from a plurality of holes which are formed through layers of plastic sheets through which row wires and column wires pass.

FIG. 23 depicts a single keyed hole from a plurality of holes which are formed through layers of plastic sheets through which row wires and column wires pass.

FIG. 24 depicts the single keyed hole as depicted in FIG. 23 from a different perspective.

FIG. 25 depicts the components of a connector for use with a keyed hole as depicted in FIGS. 22-24.

FIG. 26 depicts a connector assembly in its unlocked position.

FIG. 27 depicts a connector assembly in its locked position.

FIG. 28 depicts a connector assembly locked into a keyed hole.

Various circuits depicted in the figures can be implemented using different logic combinations or component choices as is known to those skilled in the art, and these figures are not intended to represent the only implementation but rather are shown as a general example of how to achieve a particular functionality.

### DETAILED DESCRIPTION

The present invention is an electronic voting machine (EVM) that is fast, transparent, accurate, and unhackable. Through out this patent application, reference is made to “checking a box” or “filling in or darkening an oval” (colloquial expressions meaning casting a vote) but this should be broadly construed such that the words checking, blackening, marking, filling-in, coloring in, or otherwise making or indicating a choice, selection, casting a vote, or the like are used interchangeably throughout this document and the words box, square, circle, oval, or the like, or any other area suitable for marking (e.g., a marking area) to indicate a vote cast are used interchangeably throughout this document. Also, a ballot is understood as having one or more elections and an election is understood as having zero or more choices where zero or more choices (e.g., candidates, selections, alternatives, or the like) might be presented for a given election (e.g., for a race, for an office, for or a referendum, or the like). In various places, dimensions for portions of the machine are referenced for an example embodiment and not meant to limit the invention to any specific dimensions or sizes. Also, while the example circuits of the embodiment reference common electronic components, the examples of the present inventive concepts are not to be construed as having to be of a particular technology (e.g., 7400 series TTL, CMOS, 74HC, 74HCT, CD4000 series, and the like) but rather as an example of circuitry for conveying the concepts of the present invention that could be constructed from a wide variety of technologies. Preceding a signal name with an underscore symbol (e.g., _Column1) or a dash (e.g., −EN2) signifies that a low voltage is used when asserting that signal, per convention.

### Ballots

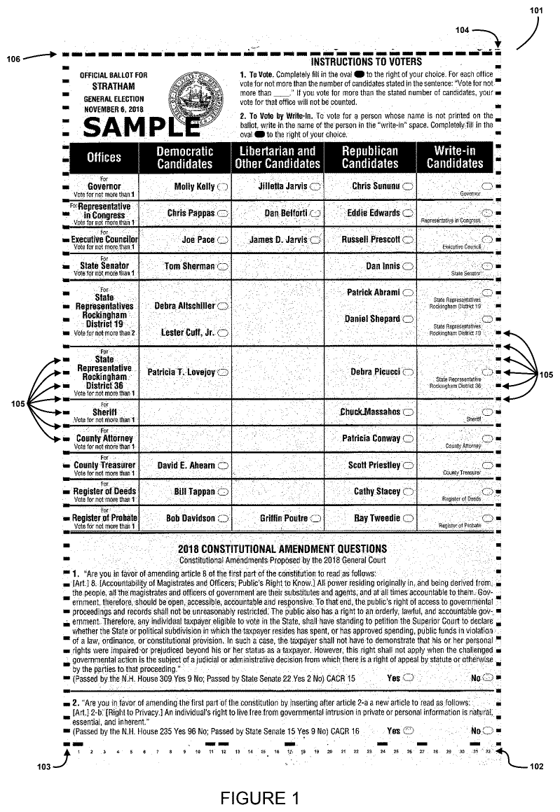

As a point of reference for the furtherance of teaching an embodiment of the present invention, a sample of a typical ballot (though by no means the rule) from the State of New Hampshire 101 consists of a paper sheet that is 8.5 inches wide and 14 inches tall (see FIG. 1). This ballot is divided into 34 columns (each being ¼ inch wide) and 53 rows (each being ¼ inch high). Note that the columns in which a vote mark could be made (columns 1-32) happen to be numbered 102 at the bottom of the ballot. The outer most columns (columns 0 103 and 33 104) contain a plurality of row marks 105 (one mark per row or line on each side of the ballot) that enable the machine to recognize each row as a ballot moves through the machine (where the short edge is the leading edge). The voter never makes a mark in these two columns. The machine ascertains the position of the columns through the placement of the column sensors—the column positions do not move. The net result is that the ballot is broken into a grid of ¼ inch by ¼ inch square marking areas. Note that the rows, like the columns, are understood to be numbered for the purpose of setting up the machine for a particular ballot, but this numbering is not necessarily printed on the ballot as is depicted for the columns. This particular ballot has 53 rows (understood to be numbered as rows 0 through 52). Blank area above row 0 and below row 52 exists on the ballot where 53×0.25″=13.25″ which leaves 0.75″ of blank area to be divided between the top (blank header) and bottom (blank footer) of a 14″ tall ballot. Note that the long edge of the ballot could be made the leading edge but then the row of optical sensors would need to have greater length to scan the rows and the row counter would become a column counter.

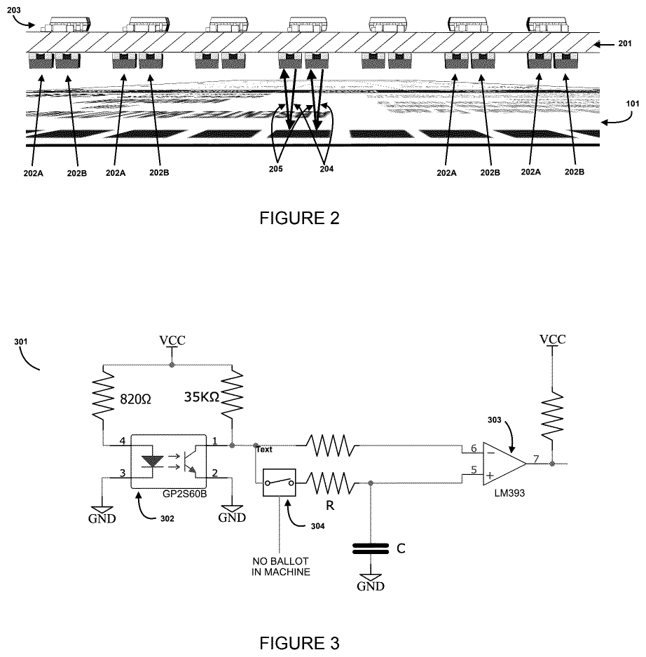

A ballot 101 slides through the machine as shown in FIG. 2 where the marked side of the ballot faces a printed circuit board (PCB) 201 (viewed from the edge with optical sensor electronic components 202A & 202B and supporting circuitry 203, together forming optical sensor circuits). The components are laid out on the PCB so as to allow the ballot close proximity without interfering with the motion of the ballot. The support circuits can be configured as a single sensor component for each column or two or more sensor components for more precise sensing of a mark in an oval. This is done in order to better detect a vote mark that might not fully fill the oval (e.g., a mark that fails to fully mark either the left or the right portion of the oval); when more than one sensor component is employed for a given column, the outputs are OR′d together. In FIG. 2, a pair of sensor components 202A & 202B are present at each column. Altogether, the sensors for each column form a line of sensors that extends from column 1 through column 32 and shall be referred to herein as the Scan Line.

As a ballot first enters the machine and before the voting areas are detected, the leading edge of the ballot passes between an LED and phototransistor of an optical interruptor sensor which enables the machine to detect a ballot entering the machine. The output of this optical interruptor sensor is a “Ballot is in Machine” signal (the inverse of which is a “No Ballot in Machine” signal). Upon reaching the “Ballot is in Machine” condition, various circuits are initialized as described in more detail below.

It should be noted that in some places in the present teaching connecting logic between two circuits may be omitted to reduce clutter in the figures (such as the omission of an inverter when one circuit outputs a signal that is asserted high, but is connected to the input of another circuit that is asserted low) but the necessity of including such connecting logic will be clear to those skilled in the art.

FIG. 3 depicts an optical sensing circuit 301 having a single sensor component 302. The optical sensing component is one of many possible optical reflector types, such as the GP2S60B manufactured by Sharp Corporation. This particular component has an LED and phototransistor in a single package where light from the LED 204 illuminates a surface positioned in front of it and reflected light 205 is sensed by the phototransistor. Separate LED/phototransistor designs are likewise contemplated for the present invention.

With a reflective sensor, when the surface is lightly colored, most of the light from the LED is reflected back whereas when the surface is dark (e.g., when an oval is filled in), little light is reflected back. When the reflected light strikes the phototransistor, it passes current in proportion to the intensity of the light. If much light is reflected back the transistor passes a lot of current and if little light is reflected back the transistor passes little current. As is understood by those skilled in the art of optical reflective sensing, the specific component values are typically determined empirically due to various parameters such as the distance of the path from diode to phototransistor, obstructions along the path (such as any apertures), and the like.

Referring to FIG. 3, when scanning a light (unmarked) area, the transistor will pass a lot of current and the voltage at its collector will approach Ground level (0 volts), whereas when scanning darkened (marked) area, the transistor will pass little current and the collector voltage will approach Vcc (e.g., 5 volts). In many cases, this signal is sufficient to detect the markings on a ballot. In some cases, such as when a ballot might be on certain colored paper and/or finer detection is desired, additional circuitry is employed. In FIG. 3, a comparator 303 is added to the circuit to compare the collector voltage to a reference voltage. In this embodiment, the collector voltage is applied to the negative terminal of the comparator 303 while the positive terminal is connected to the voltage of a sample and hold circuit comprising resistor R and capacitor C. A grey card is positioned in the machine opposite the Scan Line such that when a ballot moves through the machine it passes between the grey card and the Scan Line. When no ballot is in the machine, a reference voltage gets captured on capacitor C; this voltage level is controlled by the shade of grey on the grey card which will be lower than a blackened area. In operation, when there is no ballot in the machine, analog switch 304 closes and the collector voltage is captured by this sample and hold circuit; a higher voltage resulting from scanning a dark area will cause the comparator output to go low. This enables the machine to be set up for different ballots using a grey card having a different shade of grey depending upon the color of the ballot paper. The shade of grey is selected so that the voltage resulting from the grey card falls between the dark voltage and voltage from an unmarked area. In this way, each sensing photodiode and phototransistor pair of the optical sensing component will calibrate to the grey card level and this enables the circuit to compensate for differences in component mounting position, component aging and degradation, manufacturing tolerances, etc.

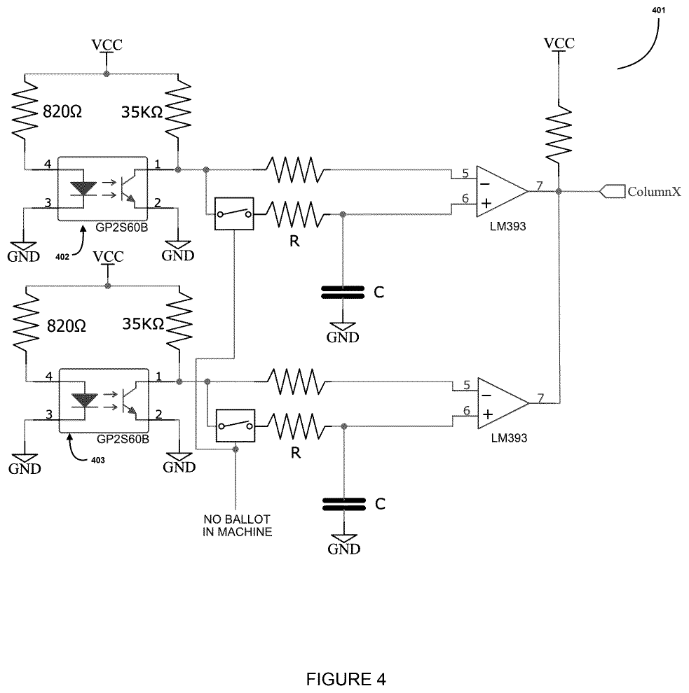

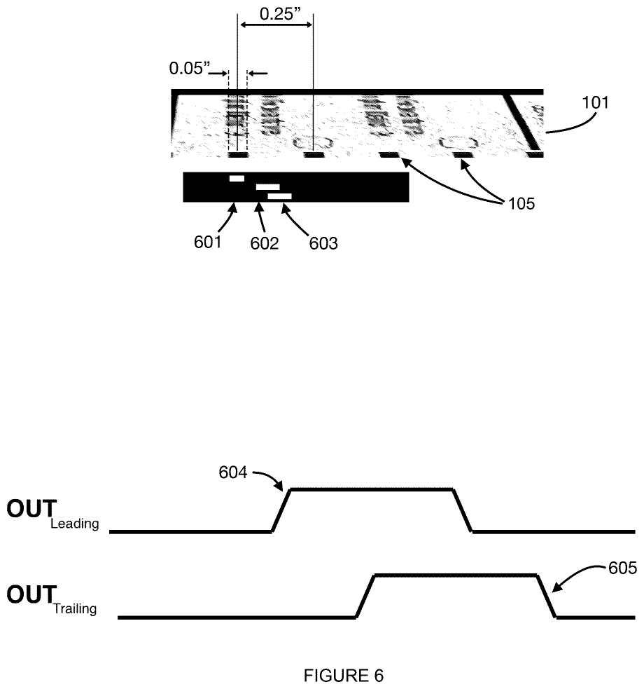

In another embodiment, as mentioned above and as depicted in FIG. 4, two sensor components 402 & 403 are employed by the optical sensing circuit 401 for a given column where the outputs are wire-OR′d together. These two (or more) sensors are positioned to simultaneously scan different portions of a single voting area so as to capture the voting mark even if it only fills a portion of the voting area. The circuit in FIG. 4 is repeated for each column (1 through 32). For scanning the row marks in columns 0 and 33 for Scan Line alignment (e.g., scanning through aperture 601 in FIG. 6), a single sensor circuit such as the circuit depicted in FIG. 3 will typically suffice because the row marks in the outer columns will not be partially filled in because the row marks are printed on the ballot when the ballot is created and will therefore fill the column 0 and 33 area.

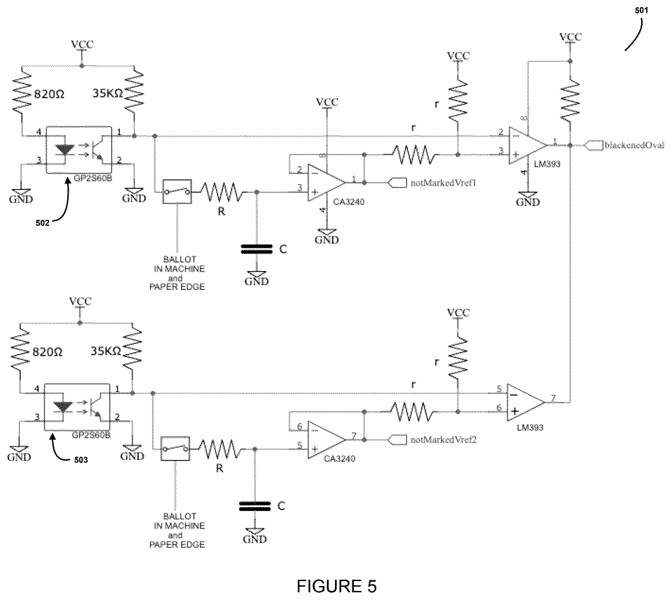

In another embodiment depicted in FIG. 5, the sample and hold analog switch is triggered when the ballot is in the machine and the Scan Line is near the ballot paper edge (i.e., in the blank header or blank footer area before a row is detected); in this instance, rather than sample the reflected light level of a grey card, the light level of the ballot paper itself is sampled to obtain a reference voltage for an unmarked area. Similarly, as will now be clear to those skilled in the art, the ballot could have a dark mark printed in the blank header or footer area in order to capture a reference voltage for a dark area. Alternatively, reference levels for both marked and unmarked areas could be captured and a threshold midway between the two reference levels could be determined and provided to the comparator.

### Row Detection

As a ballot moves through the machine and the first row on the ballot comes to be opposite the Scan Line, the sensor circuit corresponding to each column asserts the absence or presence of a dark (marked) area on that row—the sensor circuits corresponding to the vote columns (column 1 through 32) assert the presence of any vote marks and the sensor circuits corresponding to the outermost columns (column 0 and column 33) assert the presence of the row marks.

To keep a count for each row on the ballot 101, a trio of sensor circuits (e.g., each such as is depicted in FIG. 3) is positioned such that they sense the row mark 103 or 104 (column 0 or column 33) as it passes and a count is maintained of the rows scanned. A first sensor (the Row Detect Sensor) detects when the row is opposite the Scan Line while the other two provide pulses to maintain a row count. Sensing is staggered so that the count will not be changed while any row is opposite the Scan Line (i.e., actively being scanned). Sensing by the other two overlaps such that as the ballot moves forward through the machine, immediately after a row clears the Scan Line, the leading sensor of the pair first detects the row mark for the row just scanned by the Scan Line followed by the trailing sensor (while the mark is still being sensed by the leading sensor). Likewise, the mark will clear the leading sensor before it clears the trailing sensor, and the mark will clear the trailing sensor before the next row is sensed by the Row Detect Sensor.

For example, sensing a row mark 104 can be controlled by having the phototransistors view the ballot through apertures 601, 602 & 603 as depicted in FIG. 6 The size of the apertures relative to the size and spacing of the row marks 105 are generally as depicted horizontally; vertically, the three apertures would all enable viewing the row mark (e.g., the first sensor would view the left portion of the row mark, the second sensor would view the middle of the row mark, and the third sensor would view the right portion of the row mark. The Row Detect Sensor for detecting the row mark to ascertain that a row is opposite the Scan Line would view through the first aperture 601, the sensor for detecting the row mark for the leading signal would view through the second aperture 602, and the sensor for detecting the row mark for the trailing signal would view through the third aperture 603. The first aperture 601 is sized to enable the first sensor to only detect the row mark when the row is positioned opposite the Scan Line. The second and third apertures 602 & 603 are sized to enable the second and third sensors to only detect the row mark while between rows. The relative timing of the signals from the leading sensor 604 and the trailing sensor 605 as the ballot moves steadily through the machine are depicted in FIG. 6.

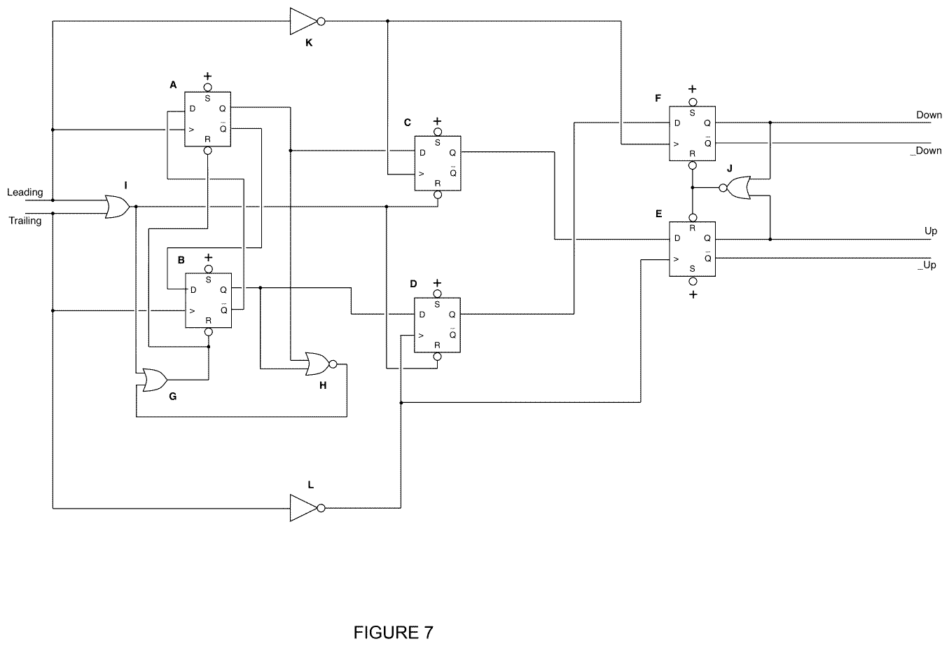

If the ballot is guaranteed to move in only one direction, only the one output 604 or 605 is required to advance the row counter, but if there is any possibility that the ballot might be reversed (e.g., if the ballot is hand fed through the machine or if the voter yanks the ballot sheet as it passes through the scanner) an optional additional ballot direction detecting circuit can be included which is depicted in FIG. 7.

FIG. 7 depicts a schematic of a ballot direction circuit to determine the direction of the ballot scan. This circuit receives the leading 604 and trailing 605 signals as inputs and converts them into up and down count pulses that are then passed to the counters in a Row Counter And Decoder circuit. The reason for having both up and down pulse outputs is to prevent loss of sync between the row number in the Row Counter And Decoder circuit and the row on the ballot being scanned. If the ballot were passed into the machine, but when it was part way through it were to be partially pulled back and then allowed to finish passing through, the number of edge marks passing the scanner would be increased by the number of marks that pass the scanner more than once. The ballot direction circuit depicted in FIG. 7 adjusts the row count pulses such that the count in the ballot row counter properly reflects the row number of the ballot row that is opposite the scanning line.

The ballot direction circuit takes two inputs (Leading and Trailing) and two outputs (Up and Down). The ballot direction logic comprises six D flip-flops (marked A through F) that manage the state of the edge mark positioning. D flip-flops A and B capture the initial edge that approaches the optical sensor pair. Note that the two D inputs are connected to the −Q output of the other D flip-flop. The clock of A is controlled by the Leading input and the clock of B is controlled by the Trailing input. This portion of the circuit is symmetrical in that the operation of A if the Leading signal occurs first mirrors the operation of B if the Trailing signal occurs first. When both the Leading and Trailing signals are low (the initial state), D flip-flops A and B are reset (Q output is low) through OR gate I. OR gate G is provided to end the reset signal once both Q outputs achieve their low initial state (the output of NOR gate H goes high when both Q outputs are low which removes the reset signal by forcing the output of OR gate G high). Ending the reset signal on A and B is necessary to prevent blocking a subsequent rising edge on their clock inputs. In addition to resetting D flip-flops A and B, when both inputs are low, the output of OR gate I is low which causes the output of AND gate P to also go low which resets D flip-flops C and D.

Keeping in mind that this circuit is symmetric (A, C, and F compared to B, D, and E), we focus for a moment on D flip-flop A; when the Leading signal rising edge occurs, it clocks in the −Q output level from D flip-flop B (initially high) present on its D input which results in the −Q output of D flip-flop A going low; this low signal is provided to D flip-flop B's D input which prevents a rising edge on the Trailing signal from changing the D flip-flop B (a low signal on the D input of a D flip-flop that is already reset results in no change if a clock pulse is received). The result of this logic is to capture the state of which signal (Leading or Trailing) occurs first-when the Leading signal occurs first, the Q output of D flip-flop A will be set high and when the Trailing signal occurs first, the Q output of D flip-flop B will be set high. Once either A or B is set, they will remain in that state until both Leading and Trailing signals return to their low (initial) levels which will reset A and B.

Now, with one signal high (e.g., the Leading signal), the next occurrence will typically be the other signal going high. This corresponds to the ballot moving consistently through the machine. But if, on the other hand, the next occurrence is that the high signal goes back low, the initial state will be restored.

Depending upon which signal (Leading or Trailing) occurred first, the Q output of either D flip-flop A (if Leading occurred first) or B (if Trailing occurred first) will be high. Since the clock inputs of D flip-flops C and F are driven by the inverted Leading signal (via inverter K) and the clock inputs of D flip-flops D and E are driven by the inverted Leading signal (via inverter L), a rising edge of the other signal will have no effect (the D flip-flops are positive edge triggered). Likewise, a falling edge on the other signal (the D flip-flops are positive edge triggered) will have no effect. In fact, multiple transitions of the other signal will have no effect as long as there is no intervening first signal change.

Looking at the case with the ballot moving consistently forward through the machine, with the one signal high, the next thing to occur is the other signal (e.g., Trailing) going high. With both signals now high (making the clock inputs to D flip-flops both low), if the first occurring signal now goes low, the corresponding middle D flip-flop (C or D) will clock through the high Q output from the corresponding first occurring D flip-flop (A or B). This will place a high signal on the D input of one of the final stage D flip-flops (E or F). If the remaining signal (Leading or Trailing) now goes low, the final stage D flip-flop will clock a high signal to either the Up or Down output (the front and middle D flip-flop stages, A and B, and C and D, will also be reset through OR gate I). Immediately upon clocking a high signal to either the Up or Down output will cause the final D flip-flop stage to be reset through NOR gate J. The result is a high going pulse on either the Up or Down output (with the other output holding low). Also, the inverted Q outputs of the final stage flip-flops will provide a low going pulse on either the _Up or _Down output (with the other output holding high) which is precisely the signal combination needed to drive a 74193 up/down counter. If propagation delays or component choices necessitate, the pulse width can be increased by adding gate delays or a delay line (e.g., such as by using one or more 74LS31's) on the output of NOR gate J.

Typically, the ballot moves consistently through the machine. However, if the ballot reverses direction at any point while a row edge mark is being read, the row number will get out of sync with the voter's marks unless precautions are taken which might present an opportunity for a nefarious actor to create a tabulation error. To prevent this, the addition of logic gates will ensure the D flip-flops are always at their correct settings. Between edge marks when in the initial state, both the Leading and Trailing signals are low.

As an edge mark is detected (in the normal forward direction), the Leading signal goes high to clock D flip-flop A, as described above, and the Q output of D flip-flop A will be high. However, if at this point the ballot were to reverse direction causing the Leading signal to go back low (i.e., return to being between edge marks), then the Leading and Trailing signals will both be low, the output of NOR gate H will be low, and D flip-flops A and B would reset to their initial state through OR gates I and G. Note that once D flip-flop A is reset, the output of NOR gate H will go high, and the initial state will be restored.

If the ballot were to have moved further into the machine to where both the Leading and Trailing signals were high when the ballot reverses direction, this would result in a toggling of the clock signal to D flip-flop D, but since the D input of D flip-flop D is low, this toggling will have no effect.

If the ballot were to have moved further into the machine to where the Trailing signal is still high but the Leading signal has gone low when the ballot reverses direction (noting that when the Leading signal went low, D flip-flop C will have clocked in the high Q output from D flip-flop A causing the Q output of D flip-flop C to be high and the output of AND gate M to be low), returning to the position where both the Leading and Trailing signals are once again high would result in 3 low inputs to OR gate N resulting in a low input to AND gate P causing D flip-flops C and D to be reset. Note that once D flip-flop C is reset, the output of NOR gate H will go high, and the prior state will be restored.

If the ballot were to have moved further into the machine to where both the Leading and Trailing signals were low, an UP pulse would be generated from D flip-flop E as described above and the edge mark will have been fully processed. If the ballot were to reverse direction at this point, a down counting operation will be initiated which will result in a down pulse from D flip-flop F if the edge mark is moved fully past the optical scanners. The symmetry of this circuit results in proper state management of the D flop-flops when the ballot is moving in either the forward or reverse direction.

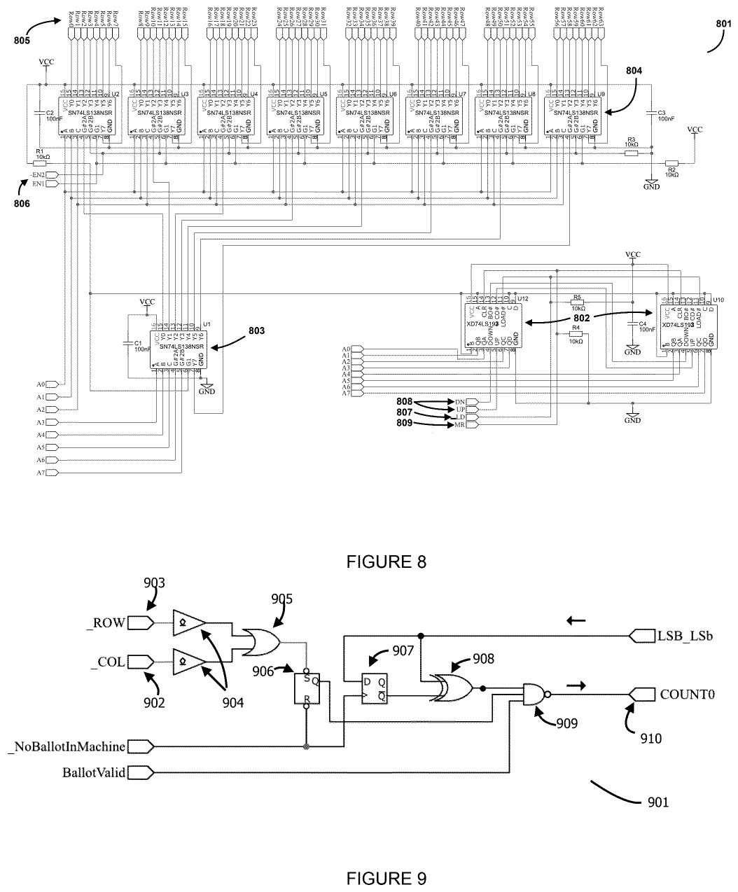

The Row Counter And Decoder circuit 801 (see FIG. 8) is a pair of 74LS193 up/down binary counters 802 driving a plurality of 74LS138 decoders. Bits A3 to A5 from the counters drive a first 74LS138 decoder 803, the outputs of which are used to select one of the remaining 74LS138 decoders 804 using bits A0 to A2 (bits A6 and A7 will always be zero). This provides row select outputs 805 for 64 rows of vote marking areas where only one row signal will be asserted (low) at a time. Two enable inputs 806 (EN1 and −EN2) control when an output row signal is asserted. When a ballot is in the machine, −EN2 is asserted low. When a row edge mark is aligned with the Scan Line (the Row Detect Sensor detects a row mark), EN1 is asserted high. In this way, a row selection only occurs when the corresponding row of the ballot is directly in front of the Scan Line. The preset inputs (A-D) of the 74LS193 are shown tied together and unused in FIG. 8, but as will be discussed below, are to be connected to a set of switches for preloading the final row number—by strobing the Load (_LD) input 807—for counting down if the ballot is inserted last row first (if counting down, the UP and DN counting inputs 808 are logically reversed to facilitate down counting). The MR input 809 is used to reset the counters to zero when No Ballot in Machine is asserted making the initialize selection _Row0.

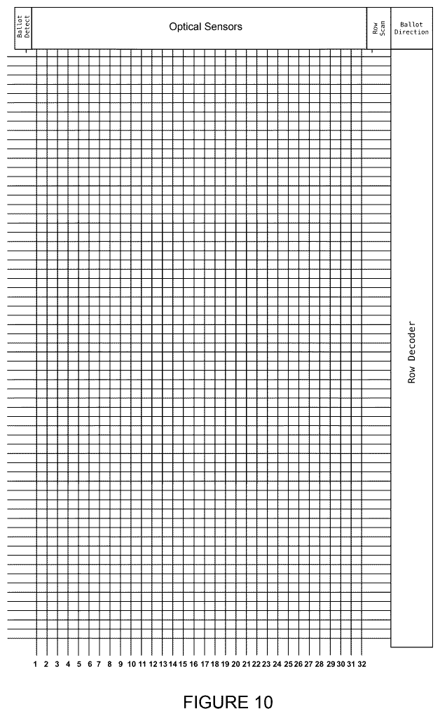

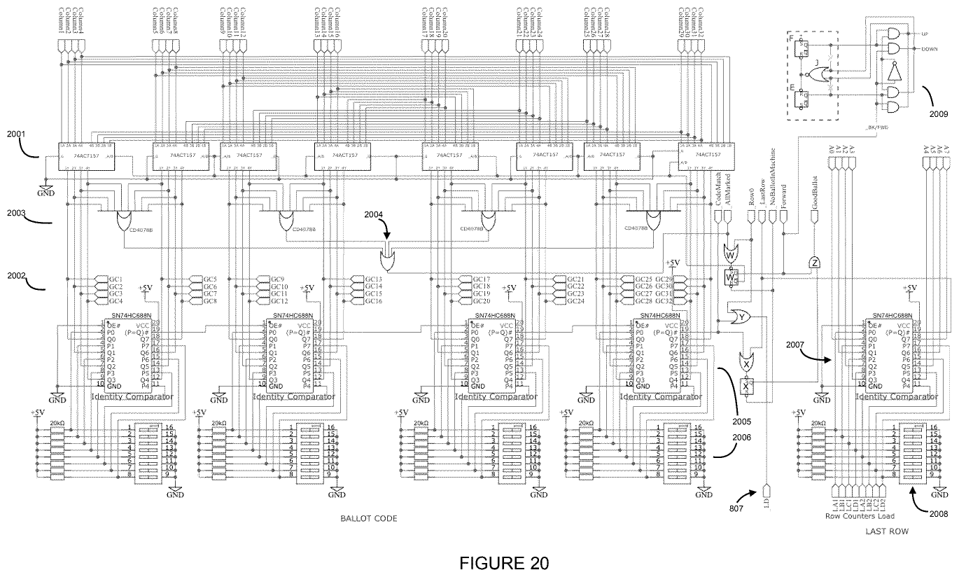

A wire grid or Patch Panel as depicted in FIG. 10 is constructed as a wire array where the row select outputs 805 connect to each of the row wires and 32 column lines from the 32 optical sensors of the Scan Line connect to the column wires. The optical sensor outputs can be connected directly to the column wires, or preferably are passed through column multiplexers (see FIG. 20) to both provide reversed columns allowing a ballot to be inserted into the machine backwards and to provide buffered column outputs (GC1-GC32) for greater output drive. Only one row selection output can be asserted at one time while any number of the optical sensing circuits for the columns can be asserted at a time depending upon ballot markings.

### Vote Capture

FIG. 9 depicts a row/column capturing SR-Latch circuit 901. One of these circuits exists for each choice (e.g., candidates, selections, alternatives, or the like) on the ballot to be tabulated. As described below for setting up the machine to tabulate a ballot, and in particular to set up a counting circuit to tabulate results for a particular oval printed on the ballot, the _COL input is patched to the column corresponding to that oval and the _ROW input is patched to the row corresponding to that oval; patching the row and column means to connect the _ROW and _COL inputs to the corresponding row wire and column wire in a wire grid or Patch Panel as depicted in FIG. 10. Initially, the row/column capturing SR-Latch 906 is reset when the _NoBallotInMachine signal is asserted. Thereafter, as the ballot passes through the machine and as each row moves past the Scan Line, the row/column capturing SR-Latch circuit corresponding to each oval is either set (if the oval is darkened in) or left untouched (in its reset state). Once all the rows on the ballot have moved through the machine, the state of each oval on that particular ballot will be captured by its corresponding SR-Latch circuit.

The _COL input 902 and the _ROW input 903 are connected to the OR gate 905 through input buffers 904 (e.g., 7417 or similar) optionally included on the _COL and ROW inputs to protect the inputs of OR gate 905 and/or condition the _COL and ROW input signals. When the _ROW input is low (i.e., the row corresponding to this SR-Latch circuit is being asserted) and the _COL input is low (i.e., the column corresponding to this SR-Latch circuit is being asserted low to indicate the presence of a filled in oval by the optical scan circuit for that column), the output of the OR gate 905 will be driven low and set the SR-Latch 906. When no ballot is in the machine, the NoBallotInMachine signal will be low and SR-Latch 906 will be reset.

As a ballot enters the machine, the rising edge of the _NoBallotInMachine signal latches the lowest bit of the least significant digit (LSB_LSb) of the current count into D-FlipFlop 907 and the output of XOR gate 908 will be high—the output of XOR gate 908 will be high whenever the state of D-FlipFlop 907 matches the state of LSB_LSb, but if the LSB_LSb changes (i.e., the count is incremented), the output of XOR gate 908 will go low. The BallotValid signal is asserted (high) when the all the rows on the ballot have been scanned by the Scan Line (including the ballot code line) and the ballot has been verified as being valid (e.g., proper format, ballot code, and no over-votes). If the oval corresponding to this SR-Latch circuit is detected as being marked, the SR-Latch 906 will be asserting (high) and if the output of XOR gate 908 is asserting (high), when the BallotValid signal is also asserted (high), the output of NAND gate 909 will go low which will provide a count pulse (falling edge) on output COUNT0 910 which goes to the tabulating counter circuit. When the falling edge propagates through the counter and its count is advanced, the lowest bit of the counter (LSB_LSb) will be toggled and this will cause the output of XOR gate 908 to go low thereby terminating the count pulse and preventing the marked oval from being counted more than once.

For each of the one or more ovals on a ballot to be tabulated, there is a corresponding row and column. An election is set up by connecting the plurality of SR-Latch/Counting/Display circuits to their corresponding column (optical scanned) circuit output and row selection output. A plurality of SR-Latch circuits will capture the state of every oval on the ballot and this plurality of states will be applied to the corresponding Counter/Display circuits upon ballot validation.

### Ballot Configuration

To accommodate connecting the _ROW and _COL inputs of the SR-Latch circuits to their corresponding column circuit output and row selection output, the machine comprises a Patch Panel or wire grid (see FIG. 10) where the wires running in a first direction (e.g., up and down) are connected to the optical sensing circuits' outputs corresponding to the columns 1 through 32, and the wires running in the orthogonal direction (e.g., side to side) are connected to the row outputs from the Row Counter And Decoder circuit. By placing a ballot behind the grid and with the wires spaced by the same distances as the rows and columns are spaced on the ballot, the grid will have a cross-over wire pair aligned to every potential vote mark location on the ballot-every oval on the ballot will be aligned with its corresponding column wire/row wire intersection point. This makes it easy to identify the column and row to be connected to the corresponding row/column capturing SR-Latch circuit OR gate. Only the locations corresponding to an oval on the ballot would have a connection to an SR-Latch circuit.

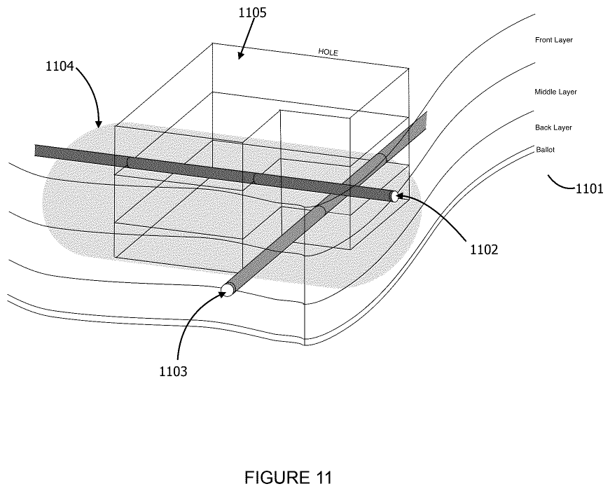

In one embodiment, clip lead pairs are constructed in which one lead is clipped to 1 of 32 columns and the other is clipped to 1 of 64 rows. In one embodiment (see FIG. 11), a layering of clear plastic sheets 1101 that is about the size of the ballot (or at least the voting area thereon) with wires embedded therein has the ballot attached to the back such that the ballot is visible through the front. Row wires 1102 running horizontally (e.g., between the front layer and the middle layer) are aligned to the rows on the ballot and column wires 1103 running vertically (between the middle layer and the back layer) are aligned to the columns on the ballot. The plastic sheet layers have openings 1105 over the vote marking areas 1104 while maintaining the spacing between the row wires and the columns wires. The openings enable access for the clip leads to be attached directly over the corresponding marking area 1104 on the ballot making clip lead attachment easy to connect to the desired column wire and row wire while also protecting the wires from being touched (which otherwise could leave dirt or finger oils on the wires). An optional fourth clear plastic sheet having no holes positioned between the ballot and the back layer clear plastic sheet will keep the clip leads from punching into the paper ballot. In an alternative embodiment, a spring loaded clip lead having two leads that pinch towards each other (onto the row wire and column wire pair) is used to make both connections simultaneously where the row contact applies pressure from in front of the row wire and by the column contact applies pressure from behind the column wire (wherein the middle clear plastic sheet layer is thick enough that the row wire and column wire are spaced apart far enough to prevent the pinching pressure from deforming the row wire and column wire from touching each other). In one embodiment, the row and column wires as well as the clip leads are plated with a material (e.g., gold) that conducts even when oxidized for better ongoing conductivity. Optionally, the corner of the hole can be formed to protect the point where the row and column wires cross and ensure that they cannot be bent into a position where they can be shorted together.

An alternate embodiment places the ballot on the front of the plastic sheets with its ovals punched or otherwise cut out such that a clip lead can pass through the opening in the ballot to make a connection to the row and column pair corresponding to that oval.

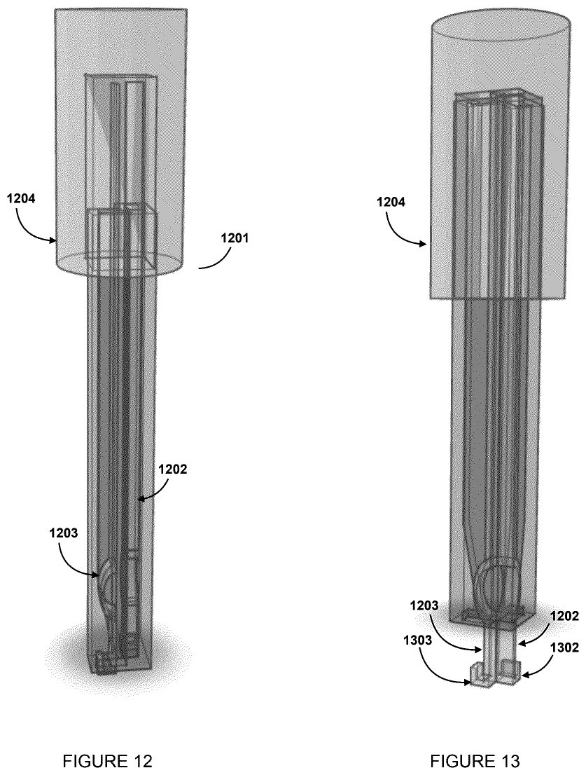

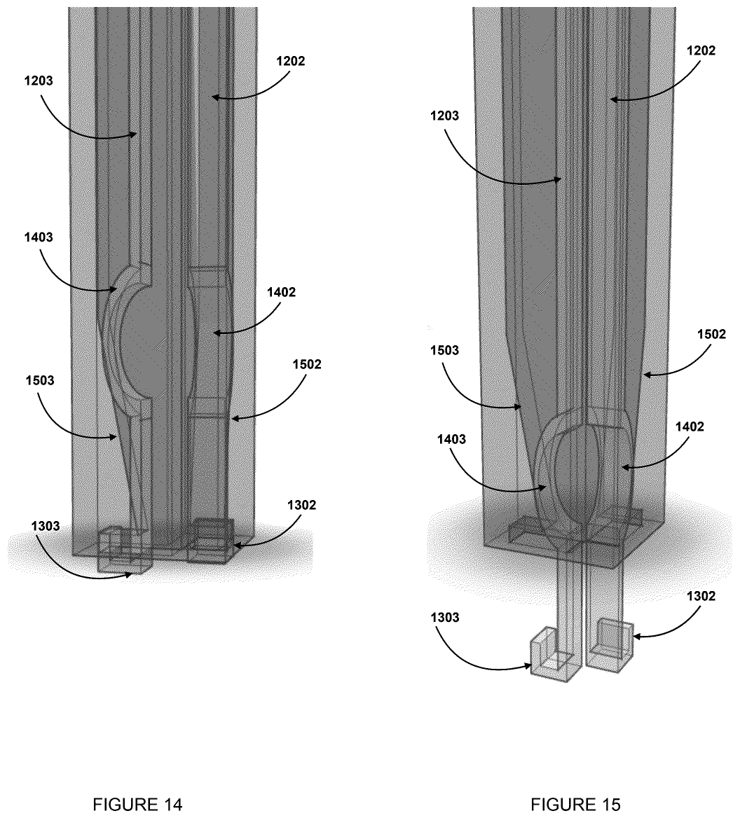

FIGS. 12, 13, 14, and 15, depict an embodiment of a clip lead 1201. The clip lead consists of two strips of metal 1202 & 1203 that are attached to, clipped into, or molded into a cap 1204 where the metal extends through a probe shaft to its tip where the metal is bent into a hook 1302 & 1303. The hook prevents the metal strip from pulling back out. Not depicted is a wire pair to the top end of each of the metal strips, the opposite ends of which go to an SR-Latch circuit. When the cap is depressed (FIG. 13) the hooked ends of the metal strips extend out of the tip of the probe shaft. When the cap is released, a spring (not shown) causes the cap to return to its original position (FIG. 12) and the hooked ends pull back to the tip of the probe shaft. To plug in a clip lead, the cap is depressed, the tip of the probe shaft is pushed into one of the holes 1105 in the sheet 1101, and the cap is released. FIGS. 14 and 15 show close-ups of the tip when the cap is released and depressed, respectively. Note that the hook 1302 & 1303 not only extends out of the probe shaft, but also moves sideways (by virtue of a contour 1402 & 1403 in the metal strip and a ramp 1502 & 1503 molded into the inside of the hole through the probe shaft) such that the hook can pass the row or column wire to be captured by the hook when the probe tip is inserted. When the cap is released, the hook simultaneously moves forward and retracts such that the wire is captured buy the hook. To unplug the clip lead, the cap is depressed and then the clip lead can be removed. Many other ways of connecting to the row and column are possible including switch arrays, patch panels, banana plugs, and the like. Other variations include adding an accordion-like set of folds, springs, or other flexing options to the top of the metal strip to provide a spring-like capability to enable the hook of both metal strips to adjust for hooking to row and column wires that are not equidistant from the front of the clear plastic sheets.

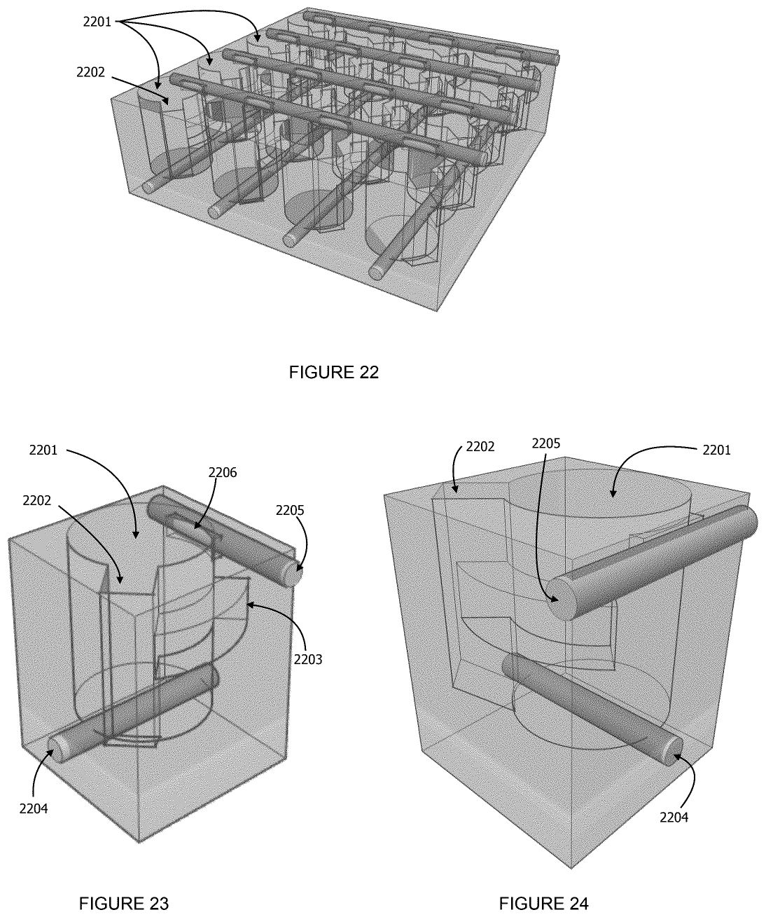

In another embodiment depicted in FIGS. 22-28, the layering of clear plastic sheets that is about the size of the ballot has a plurality of round holes 2201, each with a key notch 2202 to restrict the orientation of a spring loaded connector in this variation. FIG. 22 depicts a portion of such a sheet showing a four by four array of the round holes. FIG. 23 depicts a single keyed hole from that plurality and FIG. 24 depicts the hole shown in FIG. 23 rotated clockwise by 90 degrees. Since the ballot in the New Hampshire example is configured as columns ¼″ wide by rows ¼″ high, this single hole area has a footprint of ¼″ by ¼″. As can be seen in FIGS. 23 and 24, running down one side of the hole 2201 is a slot 2202 to provide a key to the hole such that a connector inserted into the hole can be inserted only if the connector's key is aligned with the slot. Part way down the slot, a horizontal slot 2203 that wraps part way around the hole provides a locking mechanism to prevent the connector from falling or easily coming out of the hole. Visible at the bottom of the hole is a lower horizontal wire 2204 that is exposed in the bottom of the hole for making a contact from within the hole. Also visible on the side of the hole is the upper horizontal wire 2205 (which is orthogonal to the lower horizontal wire) with an opening 2206 that allows for making a contact to the upper horizontal wire from within the hole.

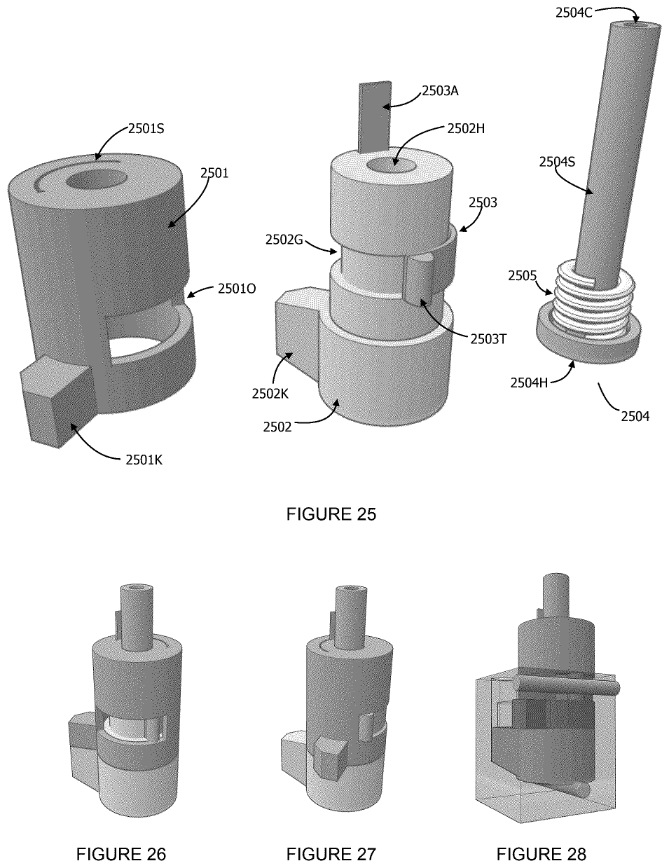

The connector comprises 5 parts (FIG. 25): a non-conductive locking top 2501, a non-conductive keyed base 2502, a conductive leaf spring 2503, a conductive pin 2504, and a compression spring 2505. There is an alignment key 2501K & 2502K on both the locking top and the keyed base. The pin is plated with a conductive material such as gold and comprises a head 2504H, a shaft 2504S, and a first connection point 2504C at the top of the shaft; the head of the pin comprises a first contact point at its bottom. The compression spring 2505 slides onto the shaft 2504S of the pin which is then inserted into the bottom of the keyed base. The compression spring causes the head of the pin to want to protrude from the bottom of the keyed base; this allows for contact pressure when the connector is locked into position as will be apparent to one skilled in the art of mechanical engineering. The shaft and the first connection point come up through the hole 2502H in the top center of the keyed base. The leaf spring comprises a curved spring and is plated with a conductive material such as gold; it comprises a raised tip 2503T at the end of the curved spring comprising a second contact point as well as an arm 2503A at the opposite end of the curved spring which rises up orthogonal to the length of the curved spring comprising a second connection point. The two connection points each accept a wire and these two wires connect to the _Row and _Col inputs of an SR-Latch circuit. The two contact points each make an electrical connection to one of the horizontal wires in the hole. The leaf spring fits into a groove 2502G around the keyed base with the arm coming up through a recess in the side of the keyed base to above the top of the keyed base; by having the arm come up through the recess, the leaf spring will remain in place (not rotate) once the locking top is slid down over the keyed base. When the locking top is slid down over the keyed base, the raised tip is pressed into a depression (not visible in the Figures) in the groove to enable the raised tip to pass inside the locking top. Once the locking top is slid into place, the raised tip of the leaf spring is exposed through an opening 25010 in the side of the locking top. A slot 2501S in the top of the locking top provides an opening for the leaf spring arm. The assembled connector is depicted in FIG. 26. One wire from a pair of wires (not shown in the Figures) is connected to one of each connection points; note that these wires are not rotated when the locking top is rotated thereby reducing stress on those wires. The assembled connector can be held together by crimping the end of the pin shaft such that it cannot be pulled back through the hole in the locking top (this crimping can additionally connect the wire to the first connection point) or by having an external retaining ring clipped onto a groove in the pin shaft where the shaft exits the locking top such that, in either case, the head of the pin is held at its desired furthest extension out of the keyed base.

FIG. 26 depicts the assembled connector in its unlocked position whereas FIG. 27 depicts the assembled connector with the locking top rotated into its locked position. When in the unlocked position, the alignment key 2502K of the keyed base is aligned with the alignment key 2501K of the locking top which allows the connector to be fully inserted into a keyed hole. Also when in the unlocked position, the leaf spring is pressed back into the groove in the keyed base by the inner surface of the locking top, causing the raised tip to be positioned back from the outer surface of the locking top thereby protecting the second contact from significantly rubbing against the inner surface of the keyed hole during insertion (which could wear off the conductive material over multiple insertions). When the connector is inserted into the keyed hole, the first contact is pressed against the lower horizontal wire at the bottom of the hole and held in good contact by the compression spring. Once the connector is inserted, the locking top is rotated to its locked position (FIG. 27). Note that the keyed base (and the pin inside) do not rotate when the locking top is rotated due to the alignment key on the keyed base in the keyed hole thereby protecting the first contact from significantly rubbing against the lower horizontal wire at the bottom of the hole during locking (which could wear off the conductive material on the pin head over multiple lock rotations). To further guard against rotation of the pin when locking, the head of the pin could be shaped other than circular with a matching shape for the recess for the pin head in the bottom of the keyed base. Also note that the slot in the top of the locking top is elongated about the hole in the top of the locking top so as to not interfere with the leaf spring arm during rotation of the locking top. When the locking top is rotated to its locked position, more and more of the leaf spring is exposed to the opening in the side of the locking top thereby allowing the raised tip to extend out from the side of the locking top.

As depicted in FIG. 28, when the locking top 2501 is rotated to its locked position, the alignment key 2501K of the locking top slides into the horizontal slot 2203 that wraps part way around the keyed hole thereby preventing the connector from being removed from the keyed hole unless the locking top is rotated back to its unlocked position (the keyed base's alignment key prevents the keyed base from rotating). When the raised tip of the leaf spring is extended out from the side of the locking top, the second contact is pressed against the upper horizontal wire at the top of the keyed hole through the opening in the side of the keyed hole and held in good contact by the leaf spring. Note that both contacts are pressed against their respective horizontal wires without rubbing to best preserve the conductive plating thereon. When the locking top is rotated back to its unlocked position, the raised tip of the leaf spring is retracted back into the side of the locking top and the alignment keys are realigned such that the connector can be removed from the keyed hole. Note that when the pin is tight against the bottom of the hole or the lower horizontal wire at the bottom of the hole, the compression spring presses up against the keyed base which in turn presses up against the locking top which provides an extra degree of locking through friction between the top surface of the locking top's key and the upper surface of the horizontal slot. Optionally, this extra locking can be increased (a) by adding a texture to these two surfaces to increase the friction, or (b) by having a portion of the upper surface of the horizontal slot near the position where the key is locked be formed higher than the upper surface of the horizontal slot where the locking top's key enters the horizontal slot (such that the compression spring will by slightly less compressed when in the locked position as compared to when the key first enters the horizontal slot).

Altogether, the above described components make up the front-end of the machine that work together to identify the presence of a ballot in the machine, scan the physical ballot, track the position of the ballot in the machine by tracking the row number, provide a mechanism to setup the machine for a particular ballot (the grid and clip leads), and the like. Once a ballot passes through the machine and the state of every oval on the ballot has been captured in an SR-Latch, the back-end of the machine takes charge. In the machine back-end will be found the Counter and Display circuits, Over/Under-vote circuits, serial output circuits.

### Vote Tabulation

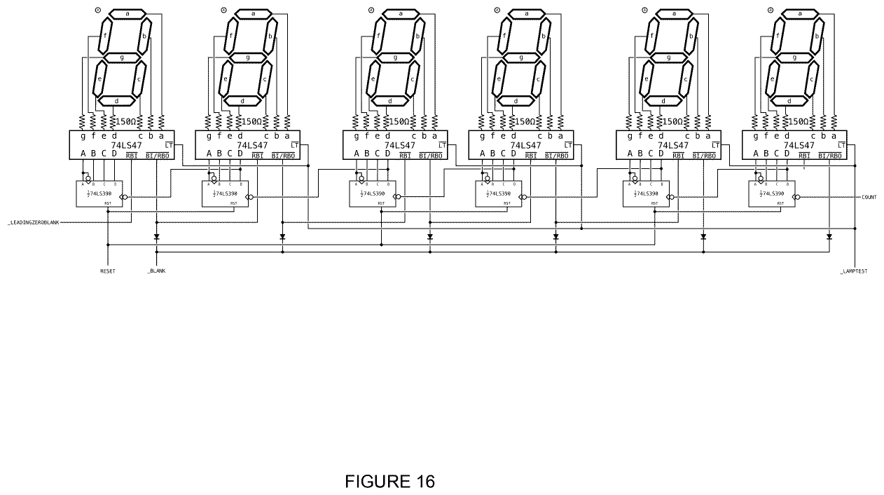

FIG. 16 depicts the Counter and Display circuit for a single vote area on the ballot. One such circuit exists for every vote markable area on the ballot. As depicted, the vote count can go as high as 999,999. Those skilled in the art will immediately recognize that this circuit could be configured for more or fewer digits. This circuit has 6 input signals: _LAMPTEST, _BLANK, RESET, _LEADINGZEROBLANK, and COUNT. Asserting _LAMPTEST will illuminate all the segments of the display to verify their proper operation whereas asserting _BLANK forces all the segments to not illuminate which may be used to conceal the count as may be done if each ballot is being tabulated while voting is ongoing. The _BLANK input can also be used to raster scan the displays to lower instantaneous power consumption. Grounding the input _LEADINGZEROBLANK will cause leading zeros to not be illuminated, however the RippleBlankOutput of the next to lowest digit is not connected to the _RBI input of the last digit such that when the count is zero a digit zero will be displayed (at the start of tabulating, it is desirable to show that the initial count is 0). The COUNT input is falling edge driven.

### Over/Under Vote Detection

In most machine embodiments, an Over-Vote and Under-Vote Detection circuit is desirable. While it would be typical for a given race on a ballot to have two choices from which one is to be selected, it is not uncommon for a race to have several or even many candidates to choose from of which one (or, for example, as is often the case in New Hampshire State Representative races, more than one) is to be selected. In the former case of a race on the ballot being a vote for one out of two race (e.g., a Yes/No referendum), a simple XOR gate can be utilized where a 1 output would indicate a properly cast vote whereas a 0 would indicate either no vote (an under-vote) or an over-vote (both ovals filled in); these two improper votes could be distinguished by either ANDing or ORing the two ovals. However, if an additional choice of “unvoted” were to be added to the race, more complex logic would be required. In New Hampshire races for State Representative, the voter might cast votes for two positions where each (two or more) party would often run two candidates plus two write-in options plus two unvoted choices resulting in a complex choose two out of eight or more selection that would require costly additional logic to properly detect. In order to provide an ability to handle the wide number of possible configurations, analog circuitry is employed. The benefit comes from using additive voltages or currents for voted candidates and window comparators to determine when races have over or under-votes.

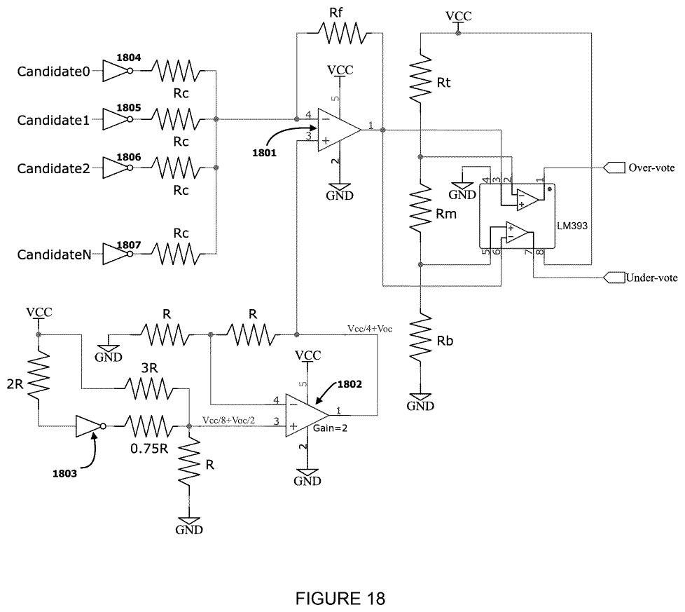

One embodiment of an over/under circuit is depicted in FIG. 18. In this embodiment, opAmp 1801 has its positive input biased by the output of OpAmp 1802 to Vcc/4+Voc where Voc is the open collector or open drain output voltage of inverter 1803.

The opAmp 1801 is in a voltage summing configuration and adjusts its output such that the negative input equals the positive input:

V−=V+=Vcc/4+Voc

When a candidate is asserted at the Q output of an SR-Latch 906, it drives a corresponding inverter 1804-1807 to pull down to Voc; the current pulled down (i) through resistor Rc is for each active candidate is approximately:

i=(Vcc/4+Voc−Voc)/Rc=Vcc/4Rc

The total current when N candidates are asserted is:

i=N Vcc/4Rc

This current also flows through the feedback resistor Rf from the opAmp's output such that the voltage across Rf is (Vout−(Vcc/4+Voc)) resulting in:

(Vout−(Vcc/4+Voc))=i Rf and (Vout−(Vcc/4+Voc))=(N Vcc/4R)Rf

Choosing a value of R for Rf gives:

(Vout−Vcc/4)=(N Vcc/4) and Vout=N Vcc/4+Vcc/4=(N+1)Vcc/4

Therefore, the output voltages for the number of candidates voted are:

| Candidates voted | Vout |
|---|---|
| 0 | Vcc/4 |
| 1 | ½ Vcc |
| 2 | ¾ Vcc |
| ≥3 | Vcc (opAmp output saturates at supply) |

For the window comparator (e.g., LM393), the upper and lower voltages are selected to generally fall halfway between the next closest values. If 1 vote is desired, the window lower and upper voltages would be 3/8Vcc and 5/8Vcc, respectively. If 2 votes are desired, the window lower and upper voltages would be 5/8Vcc and 7/8Vcc, respectively. It is not valid for a race to have zero votes and this simple embodiment cannot determine a race for which more than 2 votes are to be cast, however the number of candidates in the race is unlimited (or is limited by the cumulative leakage currents of the unvoted candidates and the other usual circuit errors). For a 5 v supply, the resistors and voltages would be:

| Candidates voted | Vout | Rb | Rm | Ru | Vlow | Vhigh |
|---|---|---|---|---|---|---|
| 0 | 1.25 v | | | | | |
| 1 | 2.50 v | 3R | 2R | 3R | 1.875 v | 3.125 v |
| 2 | 3.75 v | 5R | 2R | 1R | 3.125 v | 4.325 v |
| ≥3 | 5.00 v | | | | | |

Note that the output of opAmp 1801 is a voltage proportional to the number of candidates voted (i.e., ovals filled in). If there are a lot of candidates from which to choose, the voltage will exceed the supply unless the step corresponding to each candidate is made small but must avoid having the step be in the range of circuit noise or additive errors (e.g., due to component value variation, aging, leakage currents, and the like). To some extent, the additive errors can be managed by using high precision, good quality components. But, this is not a perfect solution. If the number of voted candidates is small (regardless of the number of available candidates), the voltage step can be as large as can fit between the supply rails, allowing the opAmp output to saturate if the voted number extends outside the number of allowed votes. However this can add complexity to the subsequent circuitry for detecting the valid voltage level (i.e., valid number voted).

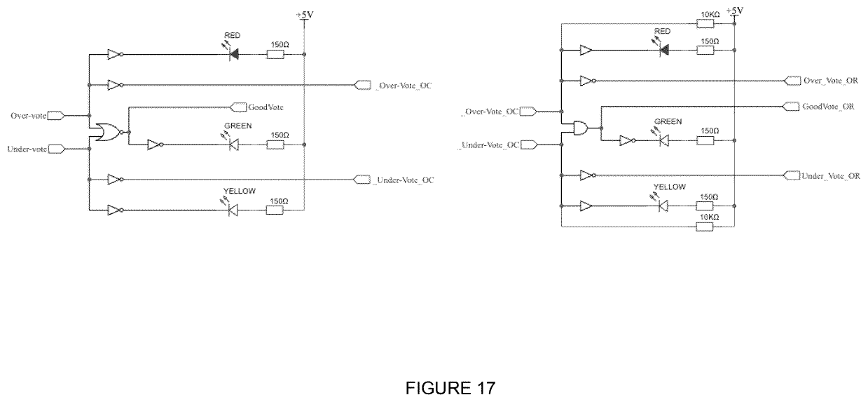

There is one over/under-vote circuit per race on the ballot. Each over-vote and under-vote circuit, regardless of how implemented, can be improved by adding LED indicators to inform the voter. FIG. 17 depicts such a circuit; the circuit on the left in FIG. 17 is repeated for each race contested on the ballot and the circuit on the right occurs once to obtain ballot-wide validation. LEDs are added to the Over-vote and Under-vote signals by including open collector buffers to provide a pull down to control LEDs. It is preferable to put a red LED to indicate Over-vote, yellow to indicate Under-vote, and green to indicate a GoodVote. These LEDs will light up for each race on the ballot. The addition of a NOR gate generates a GoodVote signal when neither Over-vote nor Under-vote is asserted. An LED is added by including an additional open collector buffer to drive a green LED.

Additional open collector buffers are added to provide ballot-wide over-vote and under-vote detection and indication. When Over-vote is detected for a race on the ballot, an additional open collector inverter generates a signal that can be wire OR′d with all other race Over-vote outputs to create a ballot wide Over-vote signal (called _Over-Vote_OC). When Under-vote is detected for a race on the ballot, an additional open collector inverter generates a signal that can be wire OR′d with all other race Under-vote outputs to create a ballot wide Under-vote signal (called _Under-Vote_OC). A ballot wide GoodVote signal is generated using an AND gate at the ballot wide circuit when neither _Over-Vote_OC nor _Under-Vote_OC is asserted. The GoodVote_OR signal can be used to activate an indicator (e.g., an LED) or actuator (e.g., a solenoid to block the path of the ballot in a manual machine or to divert or reverse the path of the ballot in a motorized machine).

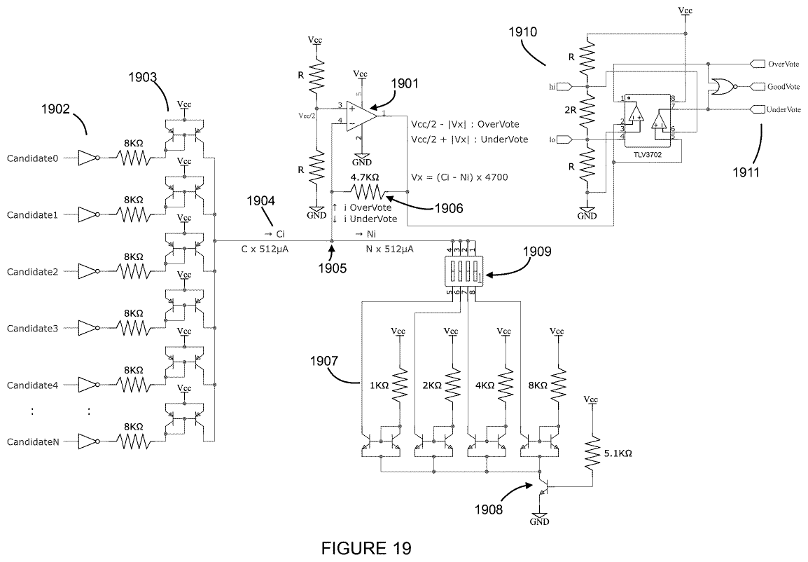

FIG. 19 depicts a preferred embodiment of an over/under circuit that uses a current adding approach. Like the prior example, candidate votes are indicated by the Candidate inputs (asserted at the Q outputs of SR-Latches 906) which drive open collector or open drain inverters 1902. The output of the inverters pull down when asserted. Each output from these open collector inverters is then used to set the current of a matched pair of transistors configured as a current mirror 1903. The mirrored currents are summed together to form a single current 1904 that is proportional to the number of candidates voted. Likewise, a reference is set by generating a plurality of currents using a binary resistor pattern. But unlike the prior embodiments, the reference is not a voltage, but rather is a current proportional to the maximum number of votes to be cast. The two currents—one proportional to the number of candidates voted and one proportional to the maximum number of votes to be cast—have opposite polarity, that is to say one is sourcing current and the other is sinking current. In the present example, the current proportional to the number of candidates voted is sourcing current using PNP transistors in the current mirrors and the current proportional to the maximum number of votes to be cast is sinking current using NPN transistors in the current mirrors (but this could be reversed if the rest of the circuit is likewise adjusted). The two currents are connected resulting in a net current which is run to an opAmp 1901 to generate a voltage proportional to the difference between the current proportional to the number of candidates voted and the current proportional to the maximum number of votes to be cast. If the number of candidates voted is greater than the maximum number of votes to be cast (an over-vote), the point where the two currents are connected will source the net current. If the number of candidates voted is less than the maximum number of votes to be cast (an under-vote), the point where the two currents are connected 1905 will sink the net current. This point where the two currents are connected is also connected to the negative terminal of the opAmp 1901 which has a feedback resistor 1906 from its output to the negative terminal (the positive terminal is biased to a set voltage, in this case to mid supply resulting in an output voltage at mid supply if the net current is zero).

Each output from the open collector inverters is connected to a current mirror through a resistor (in the present example of an embodiment, this resistor is 8 KΩ). With a 5 volt supply and accounting for the base-emitter voltage drop of about 0.7 volts and the open collector low voltage of about 0.2 volts, the current generated by the current mirror for each candidate voted is about (5 v−0.7 v−0.2 v)/8000=512 μA. The reference is set by generating a plurality of currents using a binary resistor pattern 1907 and also has, as its current corresponding to the lowest significant bit, a current mirror set by the same resistor value (8 KΩ). To compensate for the voltage drop of the open collector outputs of the candidates current generator, an additional transistor 1908 is added in a saturated state on the reference current generator; in the present example of an embodiment, the transistor is biased to drive more current than the most current that could be selected for the reference to ensure it is in a saturated state (here a 5.1 KΩ resistor from the positive supply to the transistor base). The current corresponding to the lowest significant bit is driven through a like sized resistor of 8 KΩ to create a current of (5 v−0.7 v−0.2 v)/8000=512 μA. The next significant bit would then double the current by using a resistor of half that resistance (4 KΩ), then a bit to quadruple the current with a resistor 1/4 the resistance (2 KΩ), and so on in a binary pattern to create a selectable reference current. DIP switches are then used to select the binary currents which add together to obtain the reference current.

In operation, the reference is selected by setting DIP switches 1909 for the intended number of votes to allow that binary selection of currents to be sunk from the center node. When Candidate votes are detected, the open collector outputs of the inverters pull down to near ground level thereby drawing current (512 μA per asserted candidate). As a result, the candidate current mirrors source C×512 μA is sourced into the center node. If the vote is properly voted (I.e., neither over-voted nor under-voted), the sourced current equals the sunk current and no current flows to the negative terminal of the opAmp resulting in an output voltage of half the supply. If the race is over-voted, more current will flow from the candidate current mirrors to the center node than is being sunk by the current mirrors of the reference and the excess current will flow to the opAmp which will flow through the 4.7 KΩ resistor 1906 to the opAmp's output which will drop in voltage to accommodate that current. If the race is under-voted, less current will flow from the candidate current mirrors to the center node than is being sunk by the current mirrors of the reference and the shortage of current will be drawn from the opAmp which will flow from the opAmp's elevated output through the 4.7 KΩ resistor to the center node. Even if the number of Candidates voted differs greatly from the number set by the reference, the opAmp's output will saturate to either Vcc or ground, but the window comparator output will still be correct.

The feedback resistor value is selected such that if the net current sourced or sunk is greater than the current for a single candidate (e.g., 512 μA), the voltage at the opAmp output will fall outside the window comparator 1910 threshold values, but if the net current sourced or sunk is less than the current for a single candidate (but not necessarily zero which could be due to circuit imperfections such as noise, component aging, component variations, thermal variations, imperfections in the current mirror transistor matching, and the like), the output value must fall within the window comparator threshold values (i.e., corresponding to a good-vote).

Looking at the window comparator in the example of the present embodiment, with a 5 volt supply for Vcc, a 1 KΩ resistor from the positive supply to the upper threshold voltage, a 2 KΩ resistor from the upper threshold voltage to the lower threshold voltage, and 1 KΩ resistor from the lower threshold voltage to ground, the upper threshold voltage (hi) would be about 3.75 volts and the lower threshold voltage (lo) would be about 1.25 volts which would result in an under-vote if the net current is greater than 266 μA (roughly half the current for a single candidate) and an over-vote if the net current is less than-266 μA. The window comparator yields three outputs: OverVote, GoodVote, and UnderVote. If the voting rules allow under-votes, the inverse of the OverVote signal is used in place of the GoodVote output, but if the rules require that an oval be filled in for ‘Unvoted’ and disallow an under-vote, the GoodVote output is used.

### Ballot Orientation Detection

It was stated earlier that the circuit in FIG. 4 (or an equivalent) is repeated for each column (1 through 32) from which an output occurs for each column 1 to 32 (i.e., Column1, Column2, . . . . Column32). Note that in FIG. 1, the State of New Hampshire ballot has a mark printed in the vote area of every column on Row 0 106. This enables the machine to detect the top of the ballot. Also, in the last row on the bottom of the ballot (although it could be placed on an alternative row) is a Ballot Code comprising marks in some columns and no marks in others in a binary pattern unique to that particular ballot enabling the machine to distinguish that ballot version from within a plurality of ballot version. Consequently, there is no fillable oval on either the first row (row0) nor the Ballot Code row.

FIG. 20 depicts a Row Validation circuit which receives the 32 column signals from the optical detectors (Column1-Column32). This Row Validation circuit processes the top and bottom row on the ballot. When there is not a ballot present in the machine, the signal _NoBallotInMachine will be asserted and the two SR-Latches (W & X) will be held in their reset state.

Because a ballot can be inserted with the top row first or it can be turned around and be inserted with the bottom row first (i.e., the ballot is rotated 180 degrees thereby reversing the order of the columns), 2-to-1 Multiplexers 2001 (e.g., 74ACT157's or the like) that receive the 32 signals from the optical detectors (Column1-Column32) and output the 32 column signals 2002 (GC1-GC32) in regular order or in reverse order are provided. The columns are passed in reverse order when the multiplexer _A/B inputs are high—the initial state following the insertion of a ballot into the machine because when No Ballot is in the Machine, SR-Latch W is reset and _Row0 (from select outputs 805) is selected. It should be noted that the set of 32 columns is centered on the printed ballot page so that when the ballot is inserted, each of the 32 columns will be lined up in front of one of the 32 optical column sensors regardless of the rotation.

A plurality of 8-input OR gates 2003 (e.g., CD4078B's or the like) receive the 32 Column signals (GC1-GC32) from the multiplexers which are then OR′d together with a 4-input OR gate 2004 (e.g., 74HC32 or the like) to provide the equivalent of a 32 input OR gate with a single output (_AllMarked) which is asserted (low) when every column on the ballot opposite the Scan Line has a mark resulting in all of the column sensors asserting (low). In so much as every column has a mark on the top row of the ballot, the column order from the multiplexers does not matter when reading this top row.

A plurality of Identity Comparators 2005 (e.g., 74688's or the like) also receive the 32 column signals (GC1-GC32) from the multiplexers which they compare to signals from a plurality of Ballot Code DIP Switches 2006 such that if the code printed on the bottom row of the ballot is entered on the DIP switches, a signal is asserted (_CodeMatch) if the scanned code matches the Ballot Code DIP Switch setting. (In the present example, the switches will be set to 0x34 and the row will be set to _Row52 which sets the row with the Ballot Code on it to Row52 in the machine). This is an exception have the row number output (_Row0-_Row63) change while a row is opposite the Scan Line. But, since there are no fillable ovals on either the first or last row of the ballot, no vote counting error can occur. The output from the Multiplexers should be thought of as presenting the columns in their proper order regardless of whether or not the ballot is rotated-when no ballot is in the machine, the row detection logic defaults to the ballot being rotated, but this will be reversed immediately upon recognizing the first row, as described below. Note that it is possible for _CodeMatch to be asserted when scanning other than the last row if votes cast on any row coincidently matches the ballot code pattern.

An additional Identity Comparator 2007 compares the row number (provided by A0-A7 from the Row Counter and Decoder circuit in FIG. 8) to a number set on the Last Row DIP Switches 2008 and when they are equal, the _LastRow signal is asserted (low). The Last Row DIP Switches are set to indicate the number of the last row printed on the ballot to be processed (which is typically the row on which the ballot code is printed).

When the ballot is inserted into the machine, the initial row scanned must either have every column marked (in which case the ballot is in the Forward direction) or it may contain the ballot code (in which case the ballot is in the Backward direction); it might also not have a ballot code match (e.g., if a different ballot version having a different ballot code were scanned). To determine whether the ballot is Forward or Backward, _AllMarked is OR′d with the _Row0 signal by OR gate W (to detect a Forward ballot) and _CodeMatch is OR′d with the _Row0 signal by OR gate Y (to detect a valid Backward ballot).

Note that if the ballot is inserted backwards, not only will the columns be reversed, but the row count on the counters in the Row Counter and Decoder circuit in FIG. 8 must start on the final row and count down to row zero. If ballots are allowed to be inserted backwards, to provide for row down-counting, the row counter is loaded with the last row (as set on the Last Row Switches) and the up and down count pulses are reversed as well by count reversing logic 2009 to cause the counter to count down from the last row to row 0 (the NOR gate J and two D flip-flops E & F are those shown in FIG. 7).

When the ballot is Forward, OR gate W goes low and SR-Latch W is set which causes the multiplexers to switch to pass through the columns in regular order and switches the Up/Down count pulses going to Row Counter 802 to be UP counting. A ballot code having every column marked is disallowed. The Q output of SR-Latch W indicates that a Row 0 having every column marked has been detected.

When the ballot is Backward, the first row scanned will be the Ballot Code bottom row, so if the Ballot Code matches the Ballot Code DIP Switches, the ballot is Backward and the rows are being scanned in reverse order, and the Row Counter 802 must be loaded with the number for the bottom row (the number set on the Last Row DIP Switches). To affect this, the (low) output of OR gate Y, asserts the _LD input 807; immediately upon loading Row Counter 802, the _Row0 output will be unasserted and the _LastRow signal will be asserted—this will cause the output of OR gate Y to go high and unassert the _LD input 807. Also, when the _LastRow signal is asserted (_CodeMatch will still be asserted), OR gate X will cause SR-Latch X to be set. The Q output of SR-Latch X indicates that a last row containing the correct ballot code has been detected.

If the first row revealed that the ballot is Forward (SR-Latch W will be set), validation requires that the final row contains the ballot code. If the first row revealed that the ballot is Backward (SR-Latch X will be set), validation requires that a final row (Row 0 because the Row Counter 802 will be counting DOWN to Row 0) having every column marked must be found. But OR gate W already is checking for Row 0 having every column marked. Therefore, to validate the ballot, an AND gate Z accepts the Q output of SR-Latch W indicating that a Row 0 having every column marked has been detected and the Q output of SR-Latch X indicates that a last row containing the correct ballot code has been detected; GoodBallot is the output of AND gate Z. This GoodBallot signal is gated (AND′d) with the Good_Vote_OR signal which is asserted when all the races on the ballot have been properly voted (i.e., all races are neither over-voted nor under-voted), and this result is used to incorporate the votes (clock the corresponding candidate vote counters) cast on the instant ballot into the candidate counts.

An additional feature is to add a plurality of circuits after the Multiplexers and 32 input OR logic to enable a single machine to process a plurality of different ballots (i.e., a first ballot having a first Ballot Code and a second ballot having a second Ballot Code). In this case, extra logic is needed to only allow a given Ballot Code to be processed once per voter to prevent a voter from altering the Ballot Code on a ballot to make it appear to the machine to be a different ballot thereby enabling that voter to cast more than one ballot having the same ballot code. This can be accomplished by overriding the GoodBallot signal to prevent it from being asserted more than once for a given ballot per voter. Care would have to be taken to prevent a voter from submitting ballot A and then submitting ballot B with an overvote as the overvote would enable the voter to spoil his ballot B, obtain a new ballot B, alter the ballot B Ballot Code to look like a ballot A, mark the ballot where votes would appear on a ballot A, and then submit that altered ballot B in order to trick the machine into thinking it was a ballot A thereby enabling that voter to cast two ballot A's. This care can be accomplished by holding all ballots being cast by a voter until all have been validated; if any ballot is rejected, all ballots cast by that voter would be returned to that voter to make corrections, spoil ballots, or the like so that all the ballots for a given voter would remain together.

### Results Upload

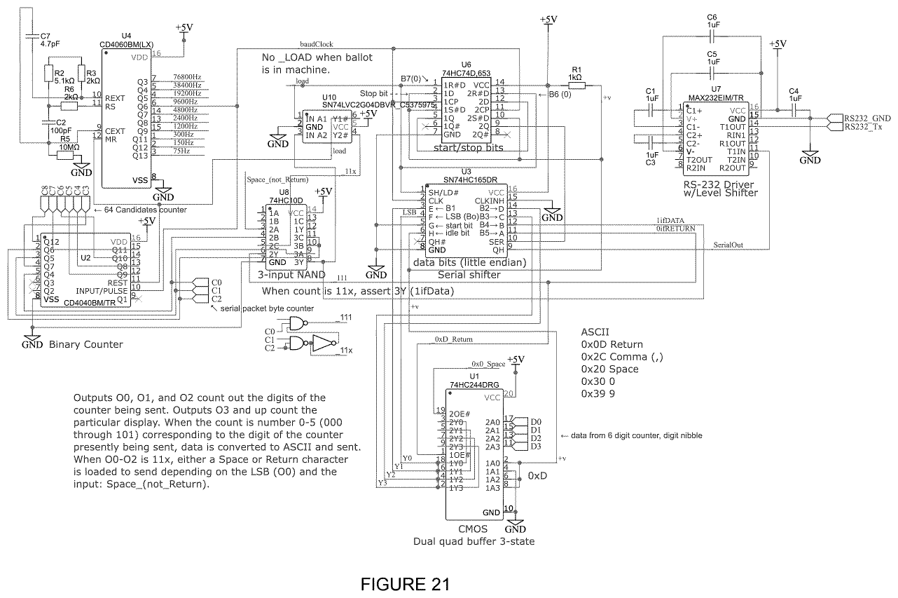

An additional optional feature for the machine, generally depicted in FIG. 21, is a serial output port. This output serves to offload an election result to prevent a scrivener's error and to fulfill some state statutes which require an offloading capability. This circuit built using discreet components and does not use a UART chip (which could be a microprocessor running firmware internally). Note also that the serial port has no serial input in order to avoid any suspicion of tampering (in the alternative, a handshake pin could be included to kick off a serial transfer). The circuit operates by generating a baud rate clock U4 to clock shift register U3 & U6 to serially shifts out bytes to an RS-232 driver chip. Parallel to serial shift register, U3, and dual flip-flop, U6, combine to form a 10 bit parallel load, serial output shift register of which U3 is parallel loaded with an idle bit, a start bit and the lowest 6 bits of the character to be transmitted as little endian bytes and U6 is parallel loaded (reset) with zeros and a serial carry in is 1 (stop bits). The top nibble of ASCII characters for the digit characters ‘0’ through ‘9’ where the bottom nibble comes from multiplexing the 4 bits of the various candidate counters. When loading a digit from the candidate counters, the 4 bits from the counter form the bottom nibble of the byte loaded while the top nibble loaded is 0x3 resulting in ASCII characters ‘0’ through ‘9’ and are received from the Candidate Counter circuit by 3-state buffer driver U1. Bits C0, C1, and C2 from binary counter U2 are decoded to select the digit of a particular candidate counter, and C3-C11 select which counter is being sent. Bits C0, C1, and C2 are also provided to 3-input NAND gate U12 to generate signals to control the top nibble-when the bits are 000 through 101 a byte from one of the Candidate counters corresponding to the digit that matches the bit count is loaded, when 110 a comma character or a space character is loaded, and when 111 a space character or return character is loaded as a function of the bits C3 through C8. Other identifying information can be generated and inserted into the serial stream by using the C3 through C8 bits. This optional feature can be implemented in many ways as will be clear to those skilled in the art in light of this teaching.

### Multiple Ballots

An additional feature is add a second machine front end oriented to read the opposite side of the ballot such that as a ballot is passed through the first machine front end it continues through the second machine front end. In this way, the ballot can be inserted in any orientation (face up, face down, top first, or bottom first) and still be properly scanned and added into the tabulation.

### Battery Backup

An additional feature is to include a battery backup device to maintain power in at least the counter circuits, and preferably the entire machine, in the event of a power outage. To better facilitate maintaining power in the counter circuits or the machine, low power components and design techniques are to be employed as are well understood by those skilled in the art.

### Ballot Box

An additional feature is an integrated ballot holding container to keep ballots after they are cast and maintain Chain of Custody. This container receives ballots directly from the machine upon ballot validation and keeps them locked inside until an election official opens the container. Ideally, the path from the tabulating and validation area to the holding area is secured to prevent any ballots from being inserted except by passing through the tabulating and validation area.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

I claim:

1. A vote tabulating device for counting one or more votes cast on a ballot where a voter makes one or more marks on the ballot to indicate the one or more votes cast and where the ballot has a plurality of areas for indicating voting preferences comprising (A) a scanning circuit for detecting a mark made on the ballot by a voter to indicate a vote cast, where the vote cast is comprised by a contest and where the contest has (a) an outcome where determination of the outcome comprises tabulating the vote cast, and (b) an intended maximum number of votes to be cast in the contest by the voter, (B) a counting circuit for tabulating a vote from the one or more votes cast on the ballot by the voter, and (C) a display circuit for displaying a count from the counting circuit, where the vote tabulating device does not comprise computer programming, and where the vote tabulating device further comprises one or more of (i) a circuit for determining if the voter cast more votes in the contest than the maximum, (ii) a circuit for determining if the voter cast fewer votes in the contest than the maximum, (iii) a circuit for determining if the voter cast votes in the contest equal to the maximum, (iv) a panel for mapping an area on the ballot where the cast vote is marked to the counting circuit, (v) a circuit for generating a serial output comprising the count from the counting circuit.

2. The vote tabulating device of claim 1, further comprising a circuit that, in response to a number of votes cast, generates one or more of (a) a voltage that is proportional to the number of votes cast, and (b) a current that is proportional to the number of votes cast.

3. The vote tabulating device of claim 2, further comprising one or more of (a) a reference voltage, and (b) a reference current proportional to a maximum number of votes to be cast.

4. The vote tabulating device of claim 3, wherein a difference between the voltage or current proportional to the number of votes cast and the voltage or current proportional to the maximum number of votes to be cast is determined.

5. The vote tabulating device of claim 1, where the ballot moves through the machine in a direction, where the plurality of areas for indicating voting preferences are arranged in a first dimension and a second dimension orthogonal to the first dimension, the first dimension being orthogonal to the direction of motion of the ballot moving through the vote tabulating device, and where the scanning circuit comprises (i) a plurality of optical sensors arranged along the first dimension, each comprising an output and (ii) logic for reversing the order of the outputs from the optical sensors along the first dimension to accommodate the ballot being rotationally oriented by approximately 180 degrees.

6. The vote tabulating device of claim 5 further comprising a logic circuit to generate a reference to order the plurality of areas along the second dimension.

7. The vote tabulating device of claim 5 further comprises logic for detecting if the ballot has been rotationally oriented by approximately 180 degrees and signaling the logic for reversing the order of the outputs to reverse the order of the outputs.

8. The vote tabulating device of claim 1 further comprising circuitry for serially transmitting a count from the counting circuit.

9. The vote tabulating device of claim 1 where (A) mapping an area on the ballot where the cast vote is marked to the counting circuit comprises making a physical connection to the panel with a connection device, (B) the panel comprises a first plurality of wires and a second plurality of wires, the first being generally orthogonal to and overlapping with the second, and where a point of closest passing of a wire from the first plurality with a wire from the second plurality corresponds to the area on the ballot where the vote is marked, (C) panel comprises a copy of the ballot where the area on the ballot where the cast vote is marked is generally aligned to the point of closest passing, and (D) the connection device makes a first electrical connection to the wire from the first plurality and a second electrical connection to the wire from the second plurality.

10. The vote tabulating device of claim 9 where (A) the connection device further comprises a first conductive device such as a wire to make a first electrical path from the first electrical connection to the counting circuit and a second conductive device such as a wire to make a second electrical path from the second electrical connection to the counting circuit and (B) the first electrical path conducts a first signal selected from a list of possible electrical signals comprising an analog signal and a digital signal and the second electrical path conducts a second signal selected from a list of possible electrical signals comprising an analog signal and a digital signal, (C) the counting circuit receives the first signal and the second signal to determine the presence or absence of a mark indicating a cast vote at the mapped area on the ballot.

11. The vote tabulating device of claim 10 where either the first signal or the second signal comprises an indication of darkness at the mapped area on the ballot comprising either (A) a digital indication of the mapped area being marked or not marked, or (B) an analog indication of the mapped area representing a degree of markedness.

12. The vote tabulating device of claim 10 where either the first signal or the second signal comprises a digital indication of the ballot being scanned being or not being at a particular position relative to the scanning circuit.

13. The vote tabulating device of claim 9 where the panel comprises a plurality of openings into which the connection device can be inserted for making the physical connection, where the connection device further comprises one or more of (i) a key to enforce the proper positioning of the connection device in the opening, (ii) a locking device to prevent the connection device from easily coming out of the opening, (iii) a first contact that presses against a wire from the first plurality of wires without significant rubbing, and (iv) a second contact that presses against a wire from the second plurality of wires without significant rubbing.

14. The vote tabulating device of claim 5 where one or more of the optical sensors comprise one or more reflective optical sensing devices contributing to the output for that optical sensor.

15. The vote tabulating device of claim 5 where one or more of the optical sensors comprise circuitry to determine a reference for (i) an amount of light reflected from an unmarked area on the ballot, (ii) an amount of light reflected from a marked area on the ballot, (iii) an amount generally centered between an amount of light reflected from an unmarked area on the ballot and an amount of light reflected from an marked area on the ballot, or (iv) an amount of light reflected from a reference color.

16. The vote tabulating device of claim 1 further comprising an indicator to indicate one or more of (i) if the voter cast more votes in a contest than the maximum, (ii) if the voter cast fewer votes in a contest than the maximum, (iii) if the voter cast votes in a contest equal to the maximum.

17. The vote tabulating device of claim 1 further comprising a device for returning a ballot to a voter upon the occurrence of one or more of (i) the voter casting more votes in a contest than the maximum, and (ii) the voter casting fewer votes in a contest than the maximum.

18. The vote tabulating device of claim 1, further comprising one or more switches for setting one or more of (i) a code to uniquely identify a ballot version, (ii) a number of rows for a ballot version, and (iii) the intended maximum number of votes to be cast in the contest by the voter.

19. The vote tabulating device of claim 6, where the reference can be advanced as the ballot moves forward and reversed as the ballot is retracted.

20. The vote tabulating device of claim 1, where a plurality of votes cast on a ballot by a voter are stored in a corresponding plurality of latches where each latch has a corresponding counter and where the ballot is validated according to a criteria and, if validated, the plurality of counters are incremented.
